(19) United States
(12) Patent Application Publication
(10) Pub. No.: US 2015/0208040 A1
(43) Pub. Date: Jul. 23, 2015

(54) OPERATING A SURVEILLANCE SYSTEM

(71) Applicant: Honeywell International Inc., Morristown, NJ (US)

(72) Inventors: Henry Chen, Beijing (CN); Hao Bai, Beijing (CN); Michelle Raymond, Minneapolis, MN (US); Vit Libal, Praha (CZ); Jan Jelinek, Naples, FL (US); Valerie Guralnik, Mound, MN (US)

(73) Assignee: Honeywell International Inc., Morristown, NJ (US)

(21) Appl. No.: 14/161,523

(22) Filed: Jan. 22, 2014

(51) Int. Cl. H04N 7/18; G06T 7/60; G06T 7/00

(52) U.S. Cl. CPC H04N 7/181; G06T 7/004; G06T 7/60; G06T 2207/10016; G06T 2207/30232

(57) ABSTRACT

Methods, systems and Devices for operating a surveillance system are described herein. One method includes determining a plurality of parameters of a video camera installed at a particular location in a facility based on a projection of an image captured by the video camera onto a virtual image captured by a virtual video camera placed at a virtual location in a building information model of the facility corresponding to the particular location, determining a two-dimensional geometry of the facility based on the building information model, wherein the geometry includes a plurality of spaces, determining a coverage of the video camera based on a portion of the plurality of parameters and the geometry, determining which spaces of the plurality of spaces are included in the coverage, and associating each space included in the coverage with a respective portion of the image.

### TECHNICAL FIELD

The present disclosure relates to devices, methods, and systems for operating a surveillance system.

### BACKGROUND

Surveillance systems can allow enhanced security in various facilities (e.g., buildings, plants, refineries, etc.). Security may be an important factor in managing a facility as various attacks targeting the facility can result in undesirable consequences (e.g., casualty, loss of asset(s), etc.).

Previous approaches to surveillance systems may not be linked to building architecture. Other previous approaches may be linked by manual input (e.g., by a user), for instance. As facilities become larger and more complex, previous approaches to operating surveillance systems may lack contextual information such as where in a facility an intruder may be and/or will be. Further, manually linking surveillance systems to building architecture may become prohibitively costly as architecture continues to become more complex.

### BRIEF DESCRIPTION OF THE DRAWINGS

FIG. 1 illustrates an image captured by a video camera of a surveillance system in accordance with one or more embodiments of the present disclosure.

FIG. 2 illustrates a virtual image captured by a virtual video camera in accordance with one or more embodiments of the present disclosure.

FIG. 3 illustrates a display including a projection of an image onto a virtual image in accordance with one or more embodiments of the present disclosure.

FIG. 4A illustrates a display of a potential area of coverage for a video camera in accordance with one or more embodiments of the present disclosure.

FIG. 4B illustrates a frustum of the video camera of FIG. 4A in accordance with one or more embodiments of the present disclosure.

FIG. 4C illustrates a coverage of the camera of FIG. 4A and FIG. 4B in accordance with one or more embodiments of the present disclosure.

FIG. 5 illustrates a display associated with an example surveillance scenario in accordance with one or more embodiments of the present disclosure.

FIG. 6 illustrates a display associated with another example surveillance scenario in accordance with one or more embodiments of the present disclosure.

FIG. 7 illustrates a computing device for operating a surveillance system in accordance with one or more embodiments of the present disclosure.

### DETAILED DESCRIPTION

Devices, methods, and systems for operating a surveillance system are described herein. For example, one or more embodiments include determining a plurality of parameters of a video camera installed at a particular location in a facility based on a projection of an image captured by the video camera onto a virtual image captured by a virtual video camera placed at a virtual location in a building information model of the facility corresponding to the particular location, determining a two-dimensional geometry of the facility based on the building information model, wherein the geometry includes a plurality of spaces, determining a coverage of the video camera based on a portion of the plurality of parameters and the geometry, determining which spaces of the plurality of spaces are included in the coverage, and associating each space included in the coverage with a respective portion of the image.

Operating a surveillance system in accordance with one or more embodiments of the present disclosure can use a three-dimensional building information model (BIM) associated with a facility to gain information regarding space geometry (e.g., topology), space connection(s), and/or access relationships. Accordingly, embodiments of the present disclosure can allow the linkage of what is captured (e.g., seen) in a video image with a corresponding location in a BIM.

Such linkage can allow embodiments of the present disclosure to determine spaces of a facility where people and/or other items are located. For example, an alarm can be triggered if a person enters a restricted space. Beyond determining a space that a person is in, embodiments of the present disclosure can determine spaces connected to that space and, therefore, where the person is likely to be in the future. Accordingly, embodiments can provide video images of camera(s) covering those connected spaces. Thus, a person's movement through the facility can be monitored by one or more users (e.g., operators, security personnel, etc.). Additionally, embodiments of the present disclosure can lock doors on a path being traveled by a person, for instance.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. Similar elements or components between different figures may be identified by the use of similar digits.

As used herein, “a” or “a number of” something can refer to one or more such things. For example, “a number of spaces” can refer to one or more spaces.

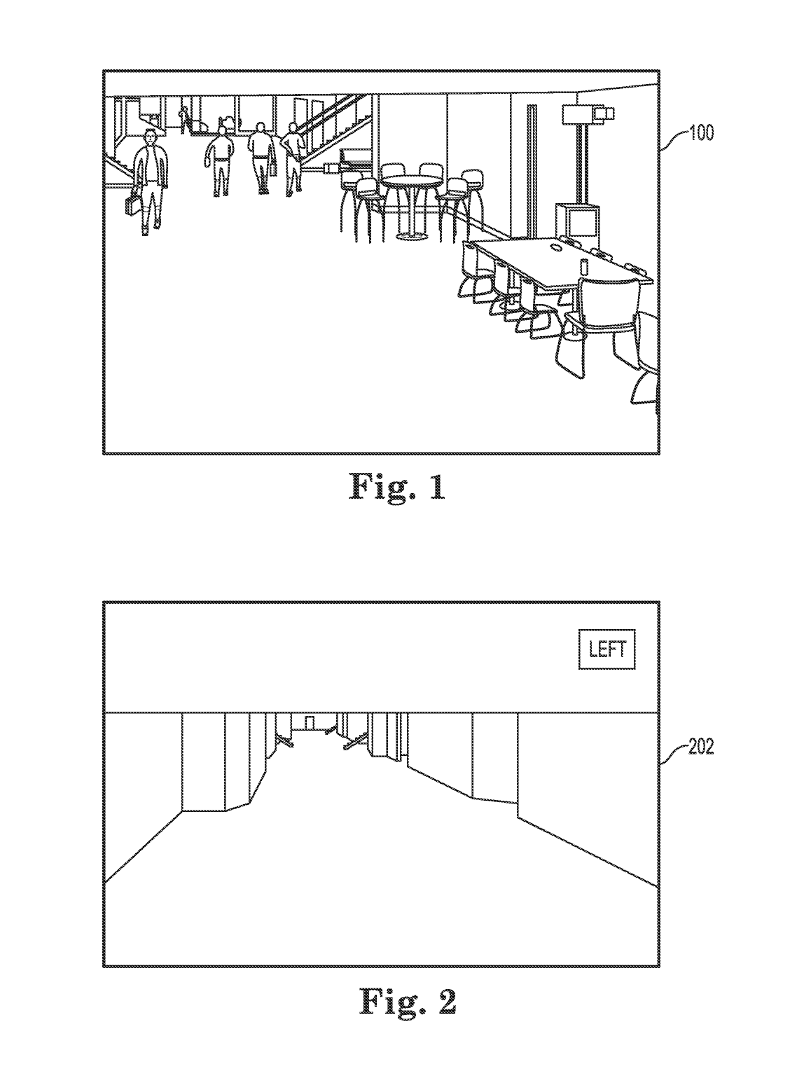

FIG. 1 illustrates an image 100 captured by a video camera of a surveillance system in accordance with one or more embodiments of the present disclosure. Image 100 can be a frame of a video image, for instance. Image 100 can be captured by a camera at a particular location associated with a facility. Video cameras in accordance with embodiments of the present disclosure are not limited to a particular type, and may be referred to herein as “cameras.” In some embodiments, cameras can be pan-tilt-zoom (PTZ) cameras, for instance.

A particular location of a camera can include a position (e.g., a geographic position) identified by geographic coordinates, for instance. A particular location can include a height (e.g., above a floor of the facility, above sea level, etc.). A particular location can include a particular location with respect to the facility and/or spaces of the facility. Spaces, as referred to herein, can include a room, for instance, though embodiments are not so limited. For example, spaces can represent areas, rooms, sections, etc. of a facility.

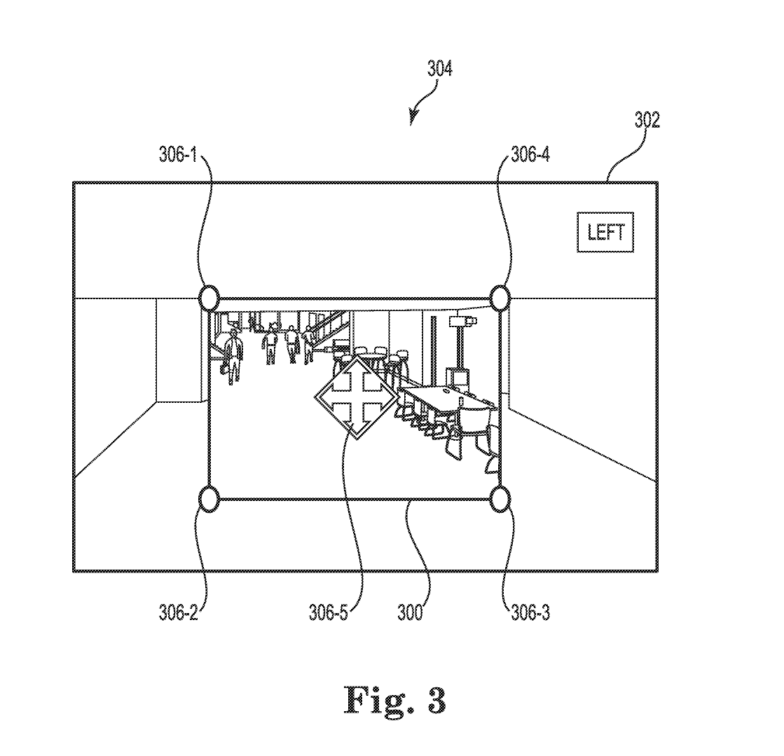

FIG. 2 illustrates a virtual image 202 captured by a virtual video camera in accordance with one or more embodiments of the present disclosure. The virtual image 202 can be captured by placing a simulation and/or representation of a video camera (e.g., a virtual video camera) in a BIM associated with the facility. The virtual video camera can be positioned in the BIM at a location corresponding to the location of the video camera in the facility (e.g., the actual and/or real-world facility). The corresponding location can be determined by installation information associated with the camera, for instance (e.g., from installation instructions, maintenance records, security information, etc). The location can include the position of the virtual camera and/or an orientation within the BIM corresponding to an orientation of the video camera in the facility.

FIG. 3 illustrates a display 304 including a projection of an image 300 onto a virtual image 302 in accordance with one or more embodiments of the present disclosure. The image 300 can be analogous to the image 100, previously discussed in connection with FIG. 1. The virtual image 302 can be analogous to the virtual image 202, previously discussed in connection with FIG. 2.

As shown in FIG. 3, the image 300 can be projected (e.g., overlaid) on to the virtual image 302. The image 300 can be displayed as partially transparent, for instance, allowing the visualization of the virtual image behind. Embodiments of the present disclosure can include a plurality of widgets allowing for the manipulation of image 300. For example, display 304 includes a widget 306-1, a widget 306-2, a widget 306-3, a widget 306-4, and a widget 306-5 (sometimes generally referred to herein as widgets 306-1-306-5). The widget 306-5 can allow a user to manipulate a position of the image 300 with respect to the virtual image 302, for instance. The widgets 306-1, 306-2, 306-3, and/or 306-4 can allow a user to manipulate a size of image 300 with respect to virtual image 302.

Utilizing widgets 306-1-306-5, a user can manipulate (e.g., adjust, modify, etc.) a position and/or a scale of the image 300. Manipulation can allow the user to align (e.g., match) one or more features of the image 300 with one or more corresponding features with the virtual image 302. For example, the user can use widgets 306-1-306-5 to align a wall in image 300 with a corresponding virtual wall in virtual image 302. Embodiments of the present disclosure can provide one or more notifications responsive to a correct alignment (e.g., a green line along a wall), for instance.

Once the user has aligned the image 300 with the virtual image 302, embodiments of the present disclosure can determine a plurality of parameters associated with the video camera. Such parameters can be used by embodiments of the present disclosure to determine a coverage (e.g., a coverage area) of the camera (discussed further below). The plurality of parameters can include a name of the camera, a position of the camera, a resolution of the camera, a pan setting of the camera, a tilt setting of the camera, a focal length of the camera, an aspect ratio of the camera, a width of the image, etc. For example, the parameters can appear as:

<Cameras>

Count=”1”>
<Camera

Name=”Camera1”
Position=”34.57,50.05,8.398848”
Resolution=”VGA”
Pan=”2.810271”
Tilt=”0.9268547”
FocalLength=”3.855025”
Aspect Ratio=”1.333”
ImageWidth=”2.4”/>

</Cameras>

A geometry (e.g., a 2-dimensional shape and/or cross-section) of the facility can be determined using the BIM associated with the facility. The Geometry can include a plurality of spaces. Spaces can represent areas, rooms, sections, etc. of a facility. Each space can be defined by a number of walls, for instance. It is to be understood that though certain spaces are discussed as examples herein, embodiments of the present disclosure are not limited to a particular number and/or type of spaces.

Spaces can be extracted from a three-dimensional BIM associated with a facility and/or from BIM data via a projection method (e.g., by projecting 3D objects of the BIM onto a 2D plan), for instance. Spaces can be polygons, though embodiments of the present disclosure are not so limited. Various information and/or attributes associated with spaces can be extracted along with the spaces themselves (e.g., semantic information, name, Globally Unique Identifier (GUID), etc.).

Connections (e.g., relationships, openings and/or doors) between the spaces can additionally be extracted from BIM data. A given space in a facility may be connected to another space via a door, for instance. Similarly, spaces extracted from BIM data may be connected via a graphical and/or semantic representation of a door. Additionally, spaces extracted from BIM data may be connected by a “virtual door.” For example, though a room may be a contiguous open space (e.g., having no physical doors therein), a BIM model associated with the room may partition the room into multiple (e.g., 2) spaces. Embodiments of the present disclosure can determine a connection between such spaces. The connection can be deemed a virtual door, for instance.

Once determined, the two-dimensional geometry (including spaces) can be used in conjunction with the determined camera parameters (previously discussed) to determine a coverage of the video camera.

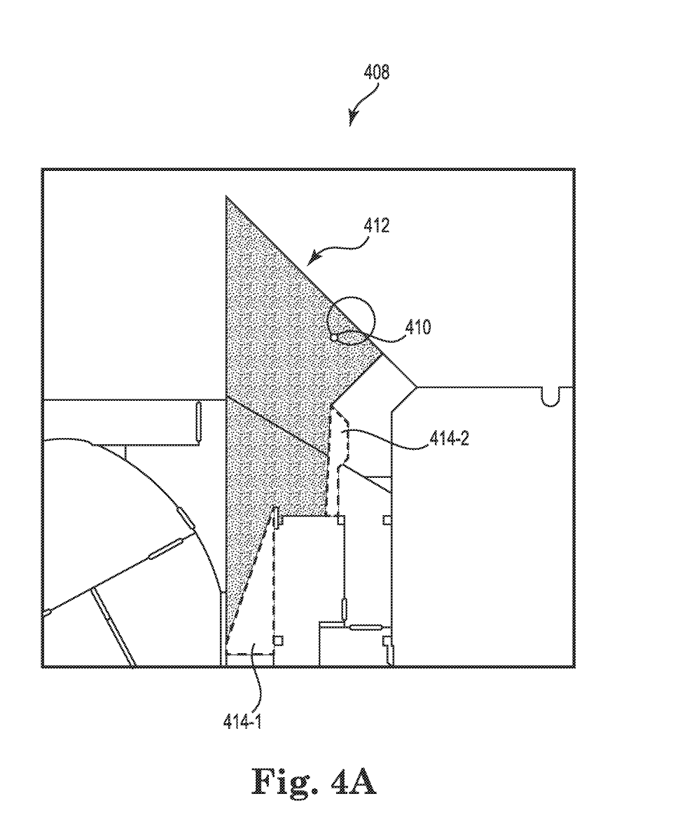

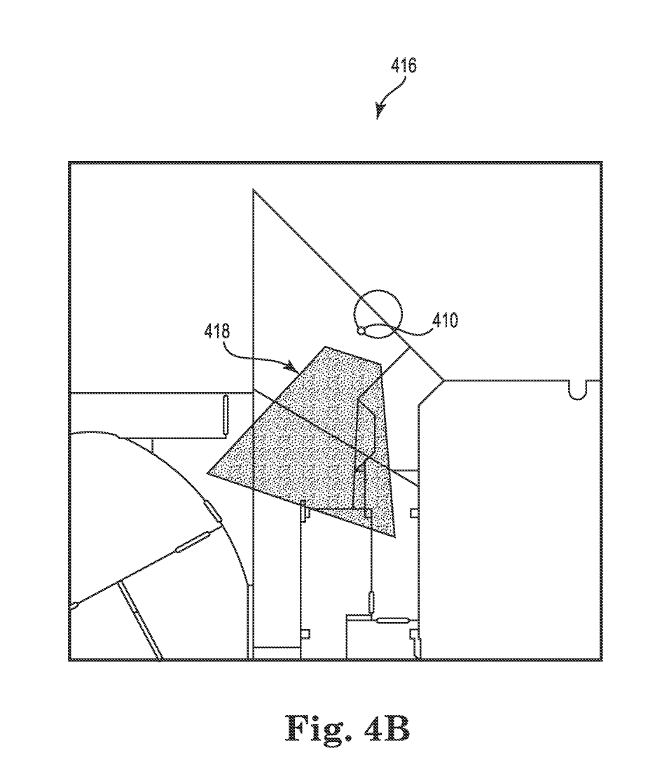

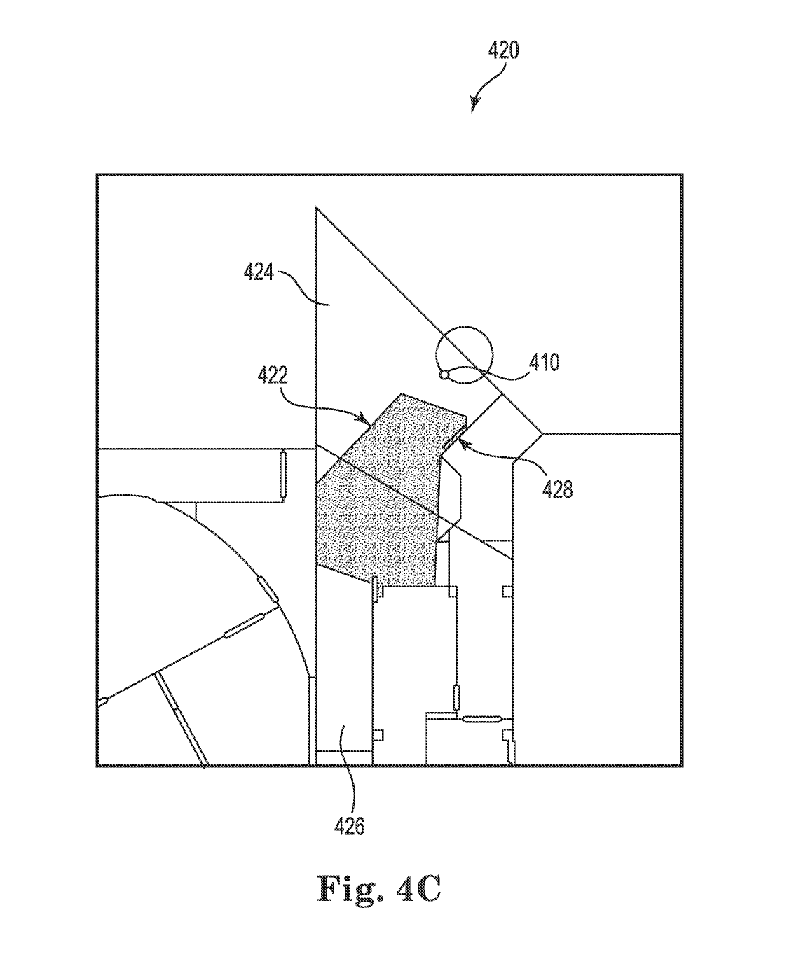

FIGS. 4A-4C illustrate displays associated with determining a coverage of a camera in accordance with one or more embodiments of the present disclosure. It is to be understood that the examples illustrated in FIGS. 4A-4C are shown for illustrative, and not limiting, purposes.

FIG. 4A illustrates a display 408 of a potential area of coverage 412 for a video camera 410 in accordance with one or more embodiments of the present disclosure. The potential area of coverage 412 can represent an area of the facility theoretically covered by camera 410 (e.g., an area not limited by a frustum of the camera, discussed below in connection with FIG. 4B).

Display 408 illustrates a portion of a facility including a number of spaces. The potential area of coverage 412 can be a polygon, and can be determined based on the position of the camera 410 and the polygons representing the spaces of the facility. As shown in FIG. 4A, potential area of coverage 412 can be limited by an occluded area 414-1 and/or an occluded area 414-2. The occluded areas 414-1 and 414-2 can represent areas not covered (e.g., visible) by the camera 410 because they are around a corner, for instance.

FIG. 4B illustrates a frustum 418 of the video camera 410 of FIG. 4A in accordance with one or more embodiments of the present disclosure. A frustum, as used herein, can be a polygon, and can refer to a field of view of camera 410. Frusta in accordance with embodiments of the present disclosure are not limited to frustum 418. Further, sizes and/or shapes of frusta in accordance with embodiments of the present disclosure are not limited to the examples discussed and/or illustrated herein. Frustum 418 can be determined based on one or more of the plurality of camera parameters previously discussed (e.g., focal length and/or image width, among other parameters).

FIG. 4C illustrates a coverage 422 of the camera 410 of FIG. 4A and FIG. 4B in accordance with one or more embodiments of the present disclosure. Coverage 422 can be determined based on a Boolean operation between the two polygons previously determined. That is, coverage 422 can be determined based on a Boolean operation between the potential area of coverage 412 of camera 410 (previously discussed in connection with FIG. 4A) and the frustum 418 of camera 410 (previously discussed in connection with FIG. 4B).

Once determined, the coverage 422 of camera 410 can be used to determine which of the spaces (e.g., a subset of the plurality of spaces) of the two-dimensional geometry are covered by camera 410 (e.g., are included in the coverage 422 of camera 410). Using spatial reasoning, for instance, embodiments of the present disclosure can determine that camera 410 covers (e.g., covers a portion of) a space 424 (shown as 1-1102), a space 426 (shown as 1-2451), and a door 428. The relationship between camera 410 and its covered spaces can be defined as:

“Camera1” covers “1-1102”

“Camera1” covers “1-2451”

“Camera1” covers “Door1”

“1-1102” covered by “Camera1”

“1-2451” covered by “Camera1”

“Door1” covered by “Camera1”

Such relationship information can be stored in an information model associated with the security system, using ontology, for instance, (e.g., in memory) and can be retrieved for various security management purposes and/or scenarios, such as those discussed below.

The relationship information can be associated with (e.g., attached to) the captured image (e.g., the camera video frame) using the determined coverage 422 and one or more of the plurality of camera parameters. For example, embodiments of the present disclosure can project the polygons of the spaces (e.g., space 424, space 426, and/or door 428) covered by camera 410 (e.g., included in coverage 422) into a coordinate system of the captured video image according to the camera parameters (e.g., using a transform matrix).

Each space of the camera coverage 422 can be associated with a respective portion of the captured image. Accordingly, if a person is determined to be in a video image captured by camera 410, embodiments of the present disclosure can determine a space in which that person is located based their location in the image by using the relationship information associated with the captured image.

Embodiments of the present disclosure can use the determined space to provide context and/or assistance to a user of the surveillance system in various surveillance scenarios. In one example, a user can specify a particular space as a restricted space. Embodiments of the present disclosure can update the relationship information of the camera(s) covering the restricted space. In the event that the camera(s) covering the restricted space capture an image of a person entering the restricted space, embodiments of the present disclosure can provide a notification (e.g., an alarm) responsive to the person entering the restricted space.

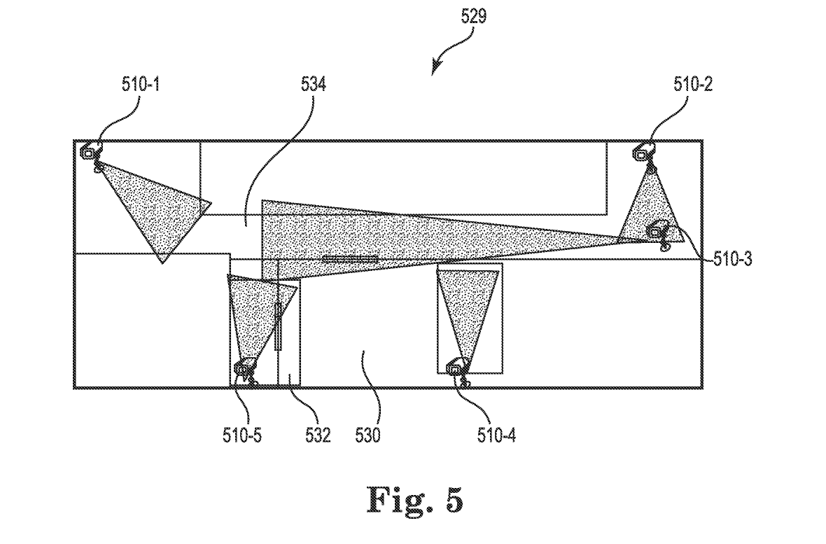

FIG. 5 illustrates a display 529 associated with an example surveillance scenario in accordance with one or more embodiments of the present disclosure. As shown in FIG. 5, display 529 illustrates a portion of a facility including a plurality of spaces: a space 530, a space 532, and a space 534. The portion of the facility illustrated in FIG. 5 includes a plurality of video cameras, each covering a respective portion of the portion of the facility. The cameras illustrated in FIG. 5 include a camera 510-1, a camera 510-2, a camera 510-3, a camera 510-4, and a camera 510-5. It is noted that the number and/or type of cameras and spaces illustrated in FIG. 5, as well as the coverages of the cameras illustrated in FIG. 5, appear only for illustrative purposes; embodiments of the present disclosure are not so limited.

In an example, a protected asset (e.g., a valuable device) has gone missing from space 530. However, space 530 is a private space having no surveillance camera coverage. Embodiments of the present disclosure can determine spaces connected to space 530 (e.g., space 532 and space 534). Embodiments of the present disclosure can determine cameras covering the spaces connected to space 530 (e.g., camera 510-1, camera 510-2, camera 510-3, and camera 510-5) based on the relationship information stored in the information model. Once determined, video images captured by the cameras covering the spaces connected to space 530 can be provided (e.g., displayed) to a user (e.g., immediately and/or in real time) such that the user can attempt to locate the missing asset and/or a person suspected of taking it.

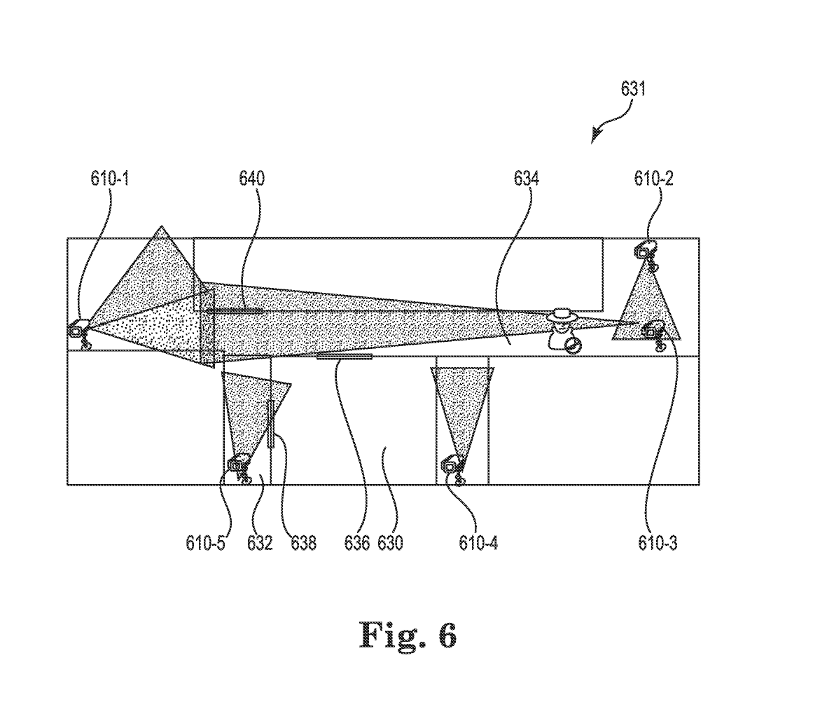

FIG. 6 illustrates a display 631 associated with another example surveillance scenario in accordance with one or more embodiments of the present disclosure. As shown in FIG. 6, display 631 illustrates a portion of a facility including a plurality of spaces: a space 630, a space 632, and a space 634. The portion of the facility includes a plurality of doors: a door 636, a door 638, and a door 640. The portion of the facility illustrated in FIG. 6 includes a plurality of video cameras, each covering a respective portion of the portion of the facility. The cameras illustrated in FIG. 6 include a camera 610-1, a camera 610-2, a camera 610-3, a camera 610-4, and a camera 610-5. It is noted that the number and/or type of cameras, doors and spaces illustrated in FIG. 6, as well as the coverages of the cameras illustrated in FIG. 6, appear only for illustrative purposes; embodiments of the present disclosure are not so limited.

In an example, an intruder has broken into space 634 and is captured in an image by camera 610-3. Embodiments of the present disclosure can log an event and/or can determine spaces and/or doors connected to space 634. Embodiments of the present disclosure can determine cameras covering the spaces and/or doors connected to space 634, and provide video images captured by the cameras covering the spaces and/or doors connected to space 634 in a manner analogous to that previously discussed in connection with FIG. 5. Embodiments of the present disclosure can provide additional (e.g., contextual) information to a user (e.g., a security operator). Such additional information can include a notification that the intruder broke into space 634 and is moving towards space 630, for instance.

Further, embodiments of the present disclosure can take action with respect to the spaces and/or doors. For example, embodiments of the present disclosure can lock (e.g., automatically lock) door 636, door 638, and/or door 640 to prevent further action (e.g., destruction) by the intruder.

Embodiments of the present disclosure can also manipulate one or more of cameras 610-1, 610-2, 610-3, 610-4, and/or 610-5. Manipulation can include manipulation of orientation and/or one or more parameters of cameras 610-1, 610-2, 610-3, 610-4, and/or 610-5 (e.g., pan, tilt, zoom, etc.) For example, embodiments of the present disclosure can pan camera 610-1 negative 30 degrees in order to capture an image of the intruder using camera 610-1.

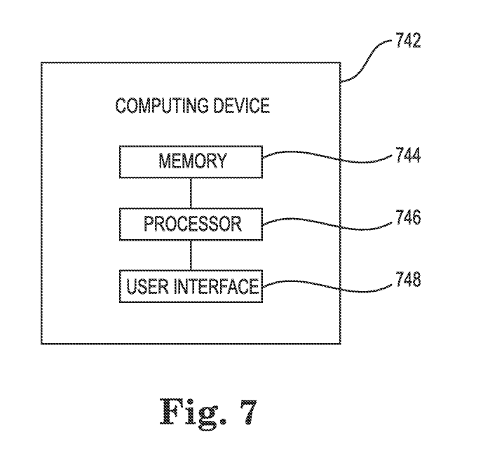

FIG. 7 illustrates a computing device 742 for operating a surveillance system in accordance with one or more embodiments of the present disclosure. Computing device 742 can be, for example, a laptop computer, a desktop computer, or a mobile device (e.g., a mobile phone, a personal digital assistant, etc.), among other types of computing devices.

As shown in FIG. 7, computing device 742 includes a memory 744 and a processor 746 coupled to memory 744. Memory 744 can be any type of storage medium that can be accessed by processor 746 to perform various examples of the present disclosure. For example, memory 744 can be a non-transitory computer readable medium having computer readable instructions (e.g., computer program instructions) stored thereon that are executable by processor 746 to operate a surveillance system in accordance with one or more embodiments of the present disclosure.

Memory 744 can be volatile or nonvolatile memory. Memory 744 can also be removable (e.g., portable) memory, or non-removable (e.g., internal) memory. For example, memory 744 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory.

Further, although memory 744 is illustrated as being located in computing device 742, embodiments of the present disclosure are not so limited. For example, memory 744 can also be located internal to another computing resource (e.g., enabling computer readable instructions to be downloaded over the Internet or another wired or wireless connection).

As shown in FIG. 7, computing device 742 can also include a user interface 748. User interface 748 can include, for example, a display (e.g., a screen). The display can be, for instance, a touch-screen (e.g., the display can include touch-screen capabilities).

User interface 748 (e.g., the display of user interface 748) can provide (e.g., display and/or present) information to a user of computing device 742. For example, user interface 748 can provide displays 100, 202, 304, 408, 416, 420, 529, and/or 631 previously described in connection with FIGS. 1-6 to the user.

Additionally, computing device 742 can receive information from the user of computing device 742 through an interaction with the user via user interface 748. For example, computing device 742 (e.g., the display of user interface 748) can receive input from the user via user interface 748. The user can enter the input into computing device 742 using, for instance, a mouse and/or keyboard associated with computing device 742, or by touching the display of user interface 748 in embodiments in which the display includes touch-screen capabilities (e.g., embodiments in which the display is a touch screen).

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for operating a surveillance system, comprising:
determining a plurality of parameters of a video camera installed at a particular location in a facility based on a projection of an image captured by the video camera onto a virtual image captured by a virtual video camera placed at a virtual location in a building information model of the facility corresponding to the particular location;
determining a two-dimensional geometry of the facility based on the building information model, wherein the geometry includes a plurality of spaces;
determining a coverage of the video camera based on a portion of the plurality of parameters and the geometry;
determining which spaces of the plurality of spaces are included in the coverage; and
associating each space included in the coverage with a respective portion of the image.

2. The method of claim 1, wherein the particular location includes a geographic position identified by geographic coordinates.

3. The method of claim 1, wherein the method includes determining the virtual location to place the virtual video camera based on installation information associated with the video camera.

4. The method of claim 1, wherein the plurality of camera parameters include a position of the video camera, a resolution of the video camera, a pan setting of the video camera, a tilt setting of the video camera, a focal length of the video camera, an aspect ratio of the video camera, and a width of the image.

5. The method of claim 1, wherein determining the coverage of the video camera includes a Boolean operation between a potential area of coverage of the video camera and a frustum of the video camera.

6. The method of claim 1, wherein associating each space included in the coverage with a respective portion of the image includes projecting a respective polygon associated with each space included in the coverage into a coordinate system of the image.

7. The method of claim 6, wherein the method includes projecting the respective polygon associated with each space included in the coverage into the coordinate system of the image using a transform matrix.

8. The method of claim 1, wherein the method includes determining a particular space in which a person is located based on relationship information associating the image with each space included in the coverage.

9. A system, comprising:
a computing device; and
a plurality of video cameras, each installed at a respective location in a facility and configured to capture a respective video image of a respective portion of the facility;
wherein the computing device is configured to:
receive the video images;
determine a respective number of spaces of the facility included in each of the received video images based on information relating each of the video images with a building information model of the facility; and
determine a particular space of the facility in which a person is present based on a location of the person in at least one of the received video images

10. The system of claim 9, wherein the computing device is configured to:
determine a space connected to the particular space; and
determine at least one of the plurality of video cameras covering the space connected to the particular space.

11. The system of claim 9, wherein the computing device is configured to:
determine a plurality of spaces connected to the particular space;
determine at least one of the plurality of video cameras covering each of the plurality of spaces connected to the particular space; and
provide a respective video image captured by the at least one of the plurality of video cameras to a user.

12. The system of claim 9, wherein the computing device is configured to provide a notification responsive to a determination that the particular space of the facility in which the person is present is a restricted location.

13. The system of claim 9, wherein the computing device is configured to determine another space of the facility toward which the person is moving.

14. The system of claim 13, wherein the computing device is configured to provide a video image associated with at least one of the plurality of video cameras covering the other space of the facility towards which the person is moving.

15. The system of claim 13, wherein the computing device is configured to lock a door associated with the other space of the facility towards which the person is moving.

16. The system of claim 9, wherein the computing device is configured to manipulate an orientation of each of the plurality of video cameras.

17. A non-transitory computer-readable medium having instructions stored thereon executable by a processor to:
receive a video image captured by a video camera installed at a particular location in a facility;
place a virtual video camera in a building information model of the facility at a virtual location associated with the particular location;
determine a virtual video image based on the placement of the virtual video camera;
project the video image onto the virtual video image;
allow a user to align the projected video image with the virtual video image;
determine a plurality of parameters of the video camera based on the aligned projected video image and virtual video image;
determine a two-dimensional geometry of the facility based on the building information model, wherein the geometry includes a plurality of spaces;
determine a coverage of the video camera based on a portion of the plurality of parameters and the geometry;
determine a subset of the plurality of spaces included in the coverage; and
associate each space of the subset with a respective portion of the video image.

18. The computer-readable medium of claim 17, wherein the instructions are executable by the processor to display the projected video image as partially transparent.

19. The computer-readable medium of claim 17, wherein the instructions are executable by the processor to:
provide a plurality of widgets associated with the projected video image; and
allow the user to align the projected video image with the virtual video image using the plurality of widgets.

20. The computer readable medium of claim 17, wherein the instructions are executable by the processor to provide a notification responsive to a correct alignment of the projected video image with the virtual video image.
